(19) United States
(12) Patent Application Publication
(10) Pub. No.: US 2009/0019301 A1
(43) Pub. Date: Jan. 15, 2009

(54) STORAGE APPARATUS

(75) Inventor: Akira Minami, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/167,693

(22) Filed: Jul. 3, 2008

(30) Foreign Application Priority Data
Jul. 9, 2007 (JP) 2007-179336

(51) Int. Cl. G06F 1/32; G06F 13/00

(52) U.S. Cl. 713/324; 710/302

(57) ABSTRACT

One aspect of the embodiments utilizes a storage apparatus includes a storage device through which data is input from and output to an external apparatus having an external interface. The storage apparatus includes a power supply control switch provided on a power supply line through which power is supplied to the storage device. A conversion control circuit converts signals mutually between a device interface of the storage device and the external interface, and performs control to turn off the power supply control switch so that supply of power to the storage device is stopped upon the storage device entering an idle state, the idle state being a state where input to and output from the external apparatus are absent.

### CROSS-REFERENCE TO RELATED APPLICATION

This application is based upon and claims the better of priority of the prior Japanese Patent Application No. 2007-179336, filed on Jul. 9, 2007, the entire contents of which are incorporated herein by reference.

### BACKGROUND

1. Field

The embodiments discussed herein are directed to a storage apparatus which may include a storage device, such as a hard disk drive, having a device interface.

2. Description of Related Art

Portable storage apparatuses of the type used in connection with an apparatus such as a personal computer via a USB (Universal Serial Bus) cable (hereinafter referred to as a storage apparatus of a first type) are commonly available.

In such a portable storage apparatus, upon connection of a USB cable from a personal computer to a USB connector for a storage apparatus, the storage apparatus is powered on, and the storage apparatus can be used to record and reproduce information or for backup of data as a subsystem of the personal computer.

For example, the portable storage apparatus includes a hard disk drive (HDD) as an internal storage device. As a device interface of the hard disk drive, usually, an ATA interface is provided. Recently, SATA (Serial ATA) interfaces are coming to be used. Thus, the storage device usually includes an interface conversion LSI that performs conversion between the ATA or SATA interface of the hard disk drive and the USB interface of the personal computer.

Such a portable storage apparatus receives power from the personal computer via the USB cable. Thus, control of power saving for reducing power consumption in idle states is an important issue.

In existing techniques of power saving control, default modes that are set for the hard disk drive are used. For example, APM (Advanced Power Management) modes 1 and 2 are defined as power saving modes in increasing order of degree of power saving, and to the user can select either mode.

In the APM mode 1, as time elapses, the status changes from an active idle state, in which a voice coil motor (VCM) is locked, to a low-power idle state, in which a head is unloaded. In the APM mode 2, in addition to the operation of the APM mode 1, as time elapses, the status changes to a standby state (sleep mode), in which a spindle motor is stopped.

In the case where the hard disk drive is connected to a personal computer via an ATA interface, it is possible to perform switching between the power saving modes using special commands from the personal computer.

However, in the case of a portable storage apparatus used in connection with a personal computer via a USB cable, since it is not possible to issue special commands for switching between the power saving modes of the hard disk drive via a USB interface, either APM mode 1 or APM mode 2 is initially set to the hard disk drive as a default power saving mode so that the hard disk drive is activated in the initially set default APM mode upon power on by the connection of the USB cable.

In the existing storage apparatus including the LSI for conversion between the USB interface and the ATA or SATA interface according to the related art of the first type, upon the hard disk drive entering the idle state, for example, if the APM mode 2 is set, the degree of power saving becomes highest when the hard disk drive is in the sleep mode, in which the spindle motor is stopped. However, for example, in the case where the portable storage apparatus is used in connection with a notebook personal computer, further reduction of power consumption is desired in order to alleviate consumption of power of a battery mounted thereon.

Furthermore, in order to further reduce power consumption of the portable storage apparatus, for example, it is conceivable to connect the storage apparatus using a USB cable only when data, such as files, is input or output, and to disconnect the USB cable on other occasions. However, it is laborious to connect and disconnect the USB cable each time, so that the above approach is not a practical solution.

In existing portable storage apparatuses, high-speed transfer is allowed by using an External Serial ATA (hereinafter referred to as “eSATA”) interface, which is an extension of an SATA interface for built-in apparatuses to externally attached apparatuses.

A portable storage apparatus having such an eSATA interface is connected to a personal computer via an eSATA cable, and is used in connection with an external special power supply device, such as an AC adaptor (hereinafter referred to as a storage apparatus of a second type).

In the existing storage apparatus according to the related art of the second type, which is externally attached using an eSATA interface, since the eSATA interface does not have a power supply of its own as opposed to a USB interface, its use is restricted to an environment where a special external power supply device, such as an AC adaptor, can be used.

Thus, in a mobile environment where an externally attached storage apparatus is used in combination with a notebook personal computer, since it is not possible to use a storage apparatus having an eSATA interface, a storage apparatus having a USB interface, which does not need a special power supply, is selected. However, a USB interface has a limit on high speed transfer, for example, of 60 MB/sec. Thus, it is desired that an eSATA interface, having a faster maximum transfer rate of 150 MB/sec, can be used without the need for a special power supply device.

Reference documents are Examined Japanese Utility Model Publication No. 3,109,868 and Japanese Laid-Open Patent Publication Nos. 2005-346123 and 2005-301390.

Accordingly, one object is to provide a storage apparatus in which power consumption is reduced further by stopping supply of power when a storage apparatus is in an idle state.

It is another object to provide a storage apparatus that can be externally attached using an eSATA interface and be used without the need for an external special power supply device, such as an AC adaptor.

### SUMMARY

According to an aspect of an embodiment, a storage apparatus includes a storage device in which data is input from and output to an external apparatus having an external interface. A power supply control switch is provided on a power supply line through which power is supplied to the storage device. A conversion control circuit converts signals mutually between a device interface of the storage device and the external interface, and performs control to turn off the power supply control switch so that supply of power to the storage device is stopped upon the storage device entering an idle state, the idle state being a state where input to and output from the external apparatus are absent.

Additional objects and advantages of the embodiment will be set forth in part in the description which follows, and in part will be obvious from the description, or may be learned by practice of the embodiment. The object and advantages of the embodiment will be realized and attained by means of the elements and combinations particularly pointed out in the appended claims.

It is to be understood that both the foregoing general description and the following detailed are exemplary and explanatory only and are not restrictive of the embodiment, as claimed.

### BRIEF DESCRIPTION OF THE DRAWINGS

FIG. 1 is a diagram showing a hard disk subsystem;

FIG. 2 is a block diagram showing the internal configuration of the hard disk subsystem;

FIG. 3 is a block diagram showing the circuit configuration of the hard disk subsystem;

FIG. 4 is a block diagram showing the circuit configuration of a conversion control LSI;

FIG. 5 is a flowchart showing a power supply controlling process;

FIG. 6 is a diagram showing a hard disk subsystem;

FIG. 7 is block diagram showing the internal configuration of the hard disk subsystem according to the embodiment shown in FIG. 6;

FIG. 8 is a block diagram showing the circuit configuration of the hard disk subsystem according to the embodiment shown in FIG. 7;

FIG. 9 is a block diagram showing the internal configuration of a hard disk subsystem;

FIG. 10A is a diagram showing the positions of connectors, in which the hard disk subsystem shown in FIG. 9 is viewed from the front side;

FIG. 10B is a diagram showing the positions of connectors, in which the hard disk subsystem shown in FIG. 9 is viewed from the rear side; and

FIG. 11 is a diagram showing another hard disk subsystem.

### DESCRIPTION OF THE PREFERRED EMBODIMENTS

### 1. First Embodiment

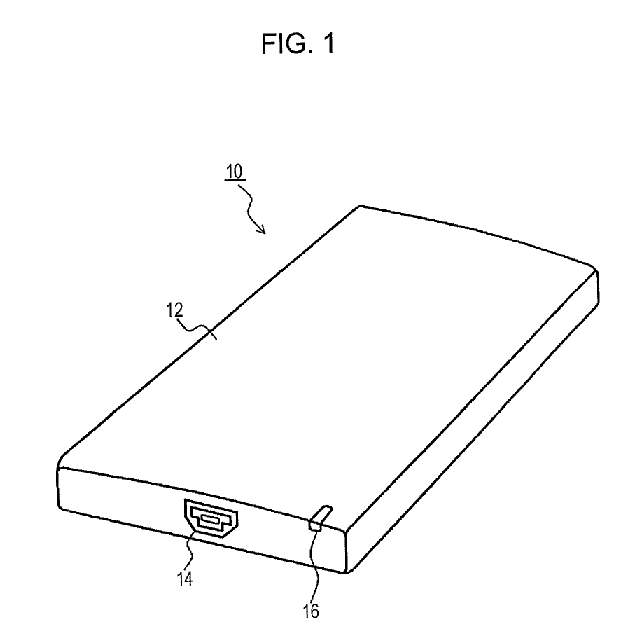

FIG. 1 is a diagram showing a portable hard disk subsystem as a first embodiment of a storage apparatus. Referring to FIG. 1, a hard disk subsystem 10 has a palm-sized and book-shaped case 12 having a thickness of about 15 to 20 mm, and a USB connector 14 and an LED indicator 16 are provided in a front portion of the case 12.

The USB connector 14 is connected to a USB cable extending from an external apparatus, such as a personal computer (host apparatus). Upon connection of the USB cable to the USB connector 14, power is supplied to the hard disk subsystem 10, so that the hard disk subsystem 10 is activated.

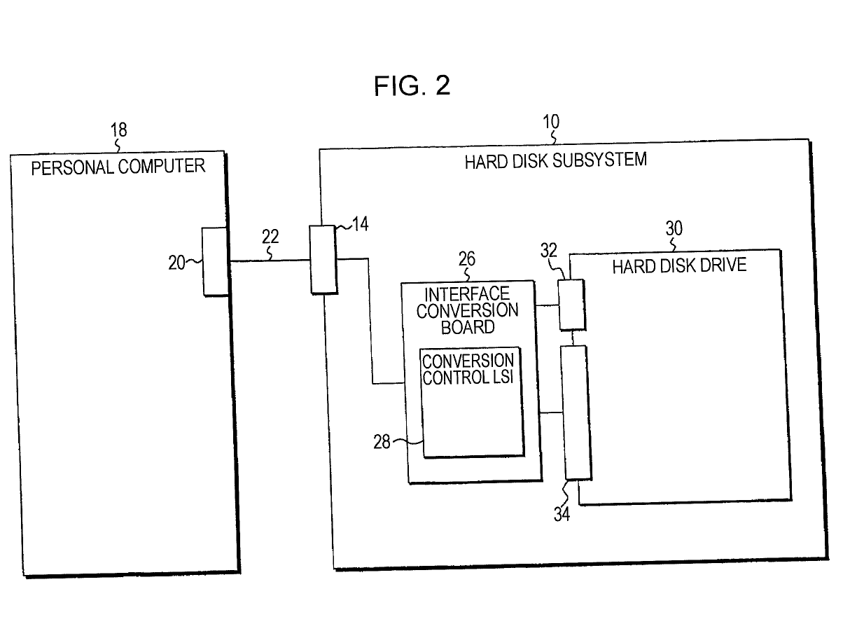

FIG. 2 is a block diagram showing the internal configuration of the hard disk subsystem 10 according to this embodiment. Referring to FIG. 2, the USB connector 14 of the hard disk subsystem 10 according to this embodiment is connected via a USB cable 22 to a USB connector 20 of a personal computer 18 as an external apparatus.

In the hard disk subsystem 10, an interface conversion board 26 is provided, and a conversion control LSI 28 is mounted on the interface conversion board 26. Furthermore, in the hard disk subsystem 10, a hard disk drive 30 that operates as a storage device is provided. For example, the hard disk drive 30 has an SATA interface as a device interface. The hard disk drive 30 has a power supply connector 32 and an SATA connector 34 individually connected to the interface conversion board 26.

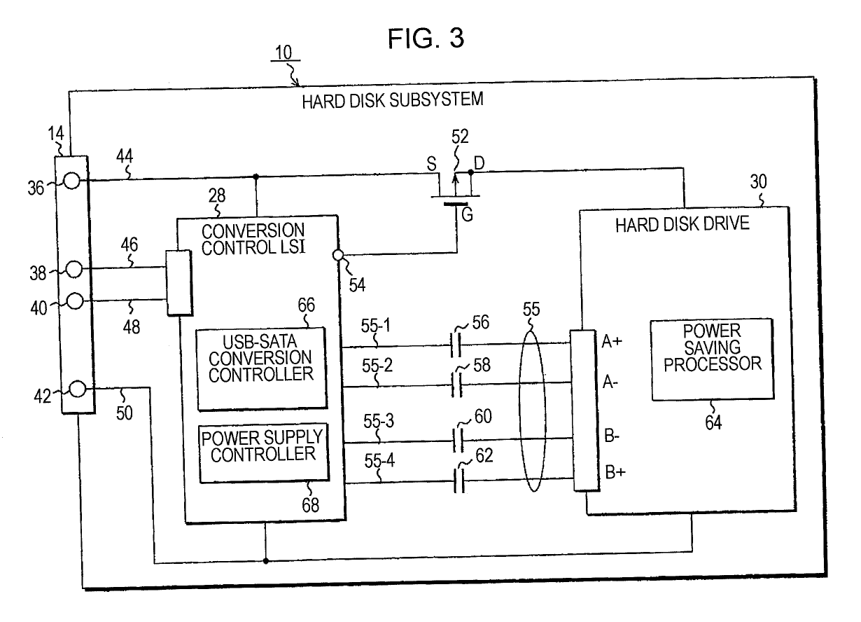

FIG. 3 is a block diagram showing the circuit configuration of the hard disk subsystem 10 according to this embodiment, together with the functional configuration thereof. Referring to FIG. 3, the hard disk subsystem 10 has the USB connector 14. The USB connector 14 has a VBUS pin 36, USB signal pins 38 and 40, and a ground pin 42. To the VBUS pin 36, DC power at 5 volts is supplied from the personal computer 18 through the USB cable 22 connected to the VBUS pin 36.

From the VBUS pin 36 of the USB connector 14, a USB power supply line 44 is extended. Furthermore, from the ground pin 42, a USB ground line 50 is extended. The USB power supply line 44 and the USB ground line 50 are connected individually to the conversion control LSI 28 and the hard disk drive 30 so that power is supplied thereto.

The hard disk drive 30 includes a power saving processor 64. The power saving processor 64 has APM mode 1 and APM mode 2 for power saving functions.

In the APM mode 1, power saving is controlled in the following manner. (1) Upon elapse of a time T1 set within a range of T1=0.1 to 0.2 seconds after entry into an idle state, the hard disk drive 30 enters an active idle power saving mode, in which the VCM is locked. (2) Upon elapse of a time T2 set within a range of T2=10 to 27.5 seconds after entry into the active idle state, the hard disk drive 30 enters a head-unloaded power saving mode, in which the head actuator is returned to an initial position in addition to locking the VCM.

On the other hand, in the APM mode 2, in addition to (1) the active idle and (2) the head unload in the APM mode 1 described above, (3) power saving is performed as described below. In (3), upon elapse of a time set within a range of T3=10 to 40 seconds after entry into the head unloaded state, the hard disk drive 30 enters a standby mode and stops the spindle motor.

The monitoring of idle time in the APM modes is performed using a timer of a CPU provided in the hard disk drive 30.

The conversion control LSI 28, provided between the USB connector 14 and the hard disk drive 30, has functions of a USB-SATA conversion controller 66 and a power supply controller 68. Furthermore, the conversion control LSI 28 has a GP-IO port 54 as a general-purpose input/output port.

As the conversion control LSI 28 that performs USB-SATA interface conversion, for example, the INIC 1610, which is a USB-to-SATA bridge manufactured by Initio Corporation, can be used.

Furthermore, in this embodiment, a P-type MOS-FET 52 that functions as a power supply control switch is connected to the USB power supply line 44 for supplying power to the hard disk drive 30, extending from the VBUS pin 36 of the USB connector 14.

The P-type MOS-FET 52 has a source S connected to the USB power supply line 44 on the side of the USB connector 14, a drain D connected on the side of the hard disk drive 30, and a gate G connected to the GP-IO port 54 of the conversion control LSI 28.

When the GP-IO port 54 is at L level, the P-type MOS-FET 52 is turned on, so that a power supply voltage of DC 5 volts is supplied to the hard disk drive 30. On the other hand, when the GP-IO port 54 is at H level, the P-type MOS-FET 52 is turned off, so that supply of power to the hard disk drive 30 is stopped.

The USB-SATA conversion controller 66 provided in the conversion control LSI 28 performs mutual conversion of input/output signals between the SATA interface of the hard disk drive 30 and the USB interface of the host connected via the USB connector 14.

Furthermore, when the timer provided in the conversion control LSI 28 has detected elapse of a predetermined time since the entry of the hard disk drive 30 into the idle state, in which input from and output to the external apparatus become absent, the power supply controller 68 provided in the conversion control LSI 28 controls the signal level of the GP-IO port 54 so that the signal level changes from L level to H level. Accordingly, the P-type MOS-FET 52 is turned off, so that supply of power to the hard disk drive 30 is stopped.

Furthermore, after the P-type MOS-FET 52 is turned off so that supply of power to the hard disk drive 30 is stopped, upon receiving an access command from the external personal computer 18, the power supply controller 68 changes the signal level of the GP-IO port 54 from H level to L level. Accordingly, the P-type MOS-FET 52 is turned on, so that power is supplied to the hard disk drive 30, whereby the hard disk drive 30 is activated again.

To be more specific, supply of power to the hard disk drive 30 by the power supply controller 68 is stopped in the following manner. In the power saving processor 64 provided in the hard disk drive 30, in the APM mode 2 described earlier, in which the degree of power saving is highest, the signal level of the GP-IO port 54 is changed to H level upon elapse of a predetermined time since (3) detection of entry into the sleep mode, in which the spindle motor is stopped. Accordingly, the P-type MOS-FET 52 is turned off, so that supply of power to the hard disk drive 30 is stopped.

Furthermore, in this embodiment, in an SATA interface signal cable 55, capacitors 56, 58, 60, and 62 are provided in the middle of four interface signal lines 55-1 to 55-4, respectively, so that the conversion control LSI 28 is AC-coupled to the SATA interface of the hard disk drive 30.

By providing the capacitors 56, 58, 60, and 62 in the middle of the respective signal lines 55-1 to 55-4 of the SATA interface signal cable 55 as described above, when supply of power to the hard disk drive 30 is stopped by controlling the P-type MOS-FET 52 through the power supply controller 68 of the conversion control LSI 28, direct currents that flow into the hard disk drive 30 from the conversion control LSI 28 via the signal lines 55-1 to 55-4 of the SATA interface signal cable 55 are cut off. This prevents power consumption caused by the flow of DC currents.

More specifically, in this embodiment, when supply of power to the hard disk drive 30 is stopped by the P-type MOS-FET 52, although supply of power to the hard disk drive 30 is stopped, power is still supplied to the conversion control LSI 28. Thus, without the capacitors 56, 58, 60, and 62, when supply of power to the hard disk drive 30 is stopped, direct currents could flow into the hard disk drive 30 from the conversion control LSI 28 via the interface signal lines 55-1 to 55-4 of the SATA interface signal cable 55, and this would result in power consumption associated with the direct currents. In the worst case, the direct currents that flow into the hard disk drive 30 that is powered off could damage the circuits of the hard disk drive 30.

In contrast, in this embodiment, since the capacitors 56, 58, 60, and 62 that cut off direct currents are provided in the middle of the interface signal lines 55-1 to 55-4, even when supply of power to the hard disk drive 30 is stopped, DC currents do not flow from the conversion control LSI 28. Thus, it is possible to reduce useless power consumption caused by direct currents, and to prevent damage on the circuits of the hard disk drive 30 caused by direct currents flowing into the circuits while the hard disk drive 30 is powered off.

The SATA interface signal cable 55 has four signal lines in total, namely, two uplink interface signal lines 55-1 and 55-2 and two downlink interface signal lines 55-3 and 55-4. Since the number of signal lines is less than that in the case of the serial ATA, even if DC cutting capacitors are provided, problems of circuit space and cost do not arise.

Furthermore, although the capacitors 56, 58, 60, and 62 are provided in the middle of the interface signal lines 55-1 to 55-4 in this embodiment, depending on the type of a hard disk drive having an SATA interface, DC cutting capacitors are connected in the middle of interface signal lines inside the hard disk drive.

In this case, direct currents that flow when the hard disk drive 30 is powered off can be cut off without externally providing the capacitors 56 to 62. Obviously, even if DC cutting capacitors are provided in the hard disk drive 30, the capacitors 56, 58, 60, and 62 may be provided on the external interface signal lines 55-1 to 55-4 as in the embodiment shown. In this case, the capacitances of the capacitors 56, 58, 60, and 62 can be determined so that the total capacitances of the capacitors 56, 58, 60, and 62 and the internal capacitors of the hard disk drive 30 take on desired values.

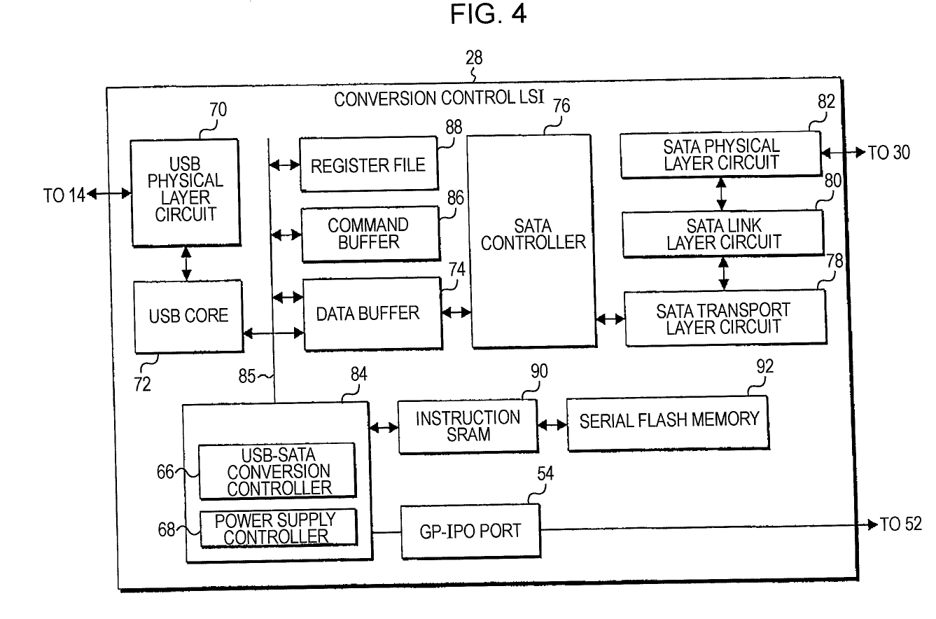

FIG. 4 is a block diagram showing the hardware configuration of the conversion control LSI 28 used in this embodiment. Referring to FIG. 4, the conversion control LSI 28 includes a USB physical layer circuit 70, a USB core circuit 72, a data buffer 74, an SATA control circuit 76, an SATA transport layer circuit 78, an SATA link layer circuit 80, and an SATA physical layer circuit 82, in that order, from the side of the USB connector 14 to the side of the hard disk drive 30.

Furthermore, a CPU 84 for controlling interface conversion is provided. A bus 85 of the CPU 84 is connected to an instruction SRAM 90 connected to a serial flash memory 92, a register file 88, a command buffer 86, and a data buffer 74.

Furthermore, the CPU 84 has the GP-IO port 54 as a general-purpose input/output port, which is connected to the gate G of the P-type MOS-FET 52 shown in FIG. 3. Thus, it is possible to control power on and power off of the hard disk drive 30.

The CPU 84 includes the USB-SATA conversion controller 66 and the power supply controller 68 as functions executed by performing control operations according to programs. When the USB-SATA conversion controller 66 controls conversion between the USB interface and the SATA interface, for example, in the case of controlling USB-to-SATA conversion, interface signals are converted along a path formed of the USB physical layer circuit 70, the USB core circuit 72, the data buffer 74, the SATA controller 76, the SATA transport layer circuit 78, the SATA link layer circuit 80, and the SATA physical layer circuit 82.

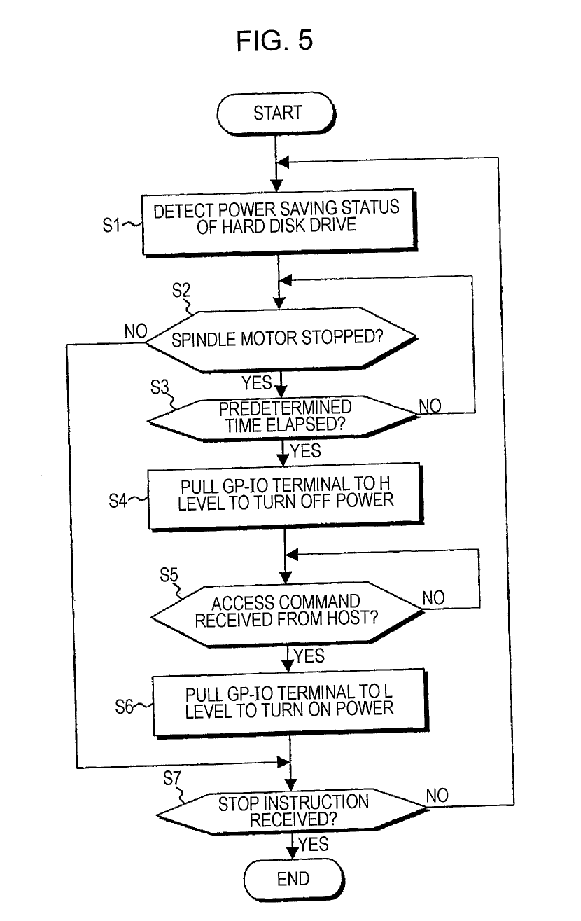

FIG. 5 is a flowchart showing a power supply controlling process according to this embodiment. This process is implemented by execution of a program corresponding to the power supply controller 68 by the CPU 84 provided in the conversion control LSI 28 shown in FIG. 4.

Referring to FIG. 5, in the power supply controlling process according to this embodiment, in step S1, a power saving status of the hard disk drive 30 is monitored. When the sleep mode, in which the spindle motor is stopped, is detected in step S2, the process proceeds to step S3. Upon detecting elapse of a predetermined time through monitoring of a timer by the CPU 84, the process proceeds to step S4. In step S4, the signal level at the GP-IO port 54 is changed from L level to H level. Accordingly, the P-type MOS-FET 52 shown in FIG. 3 is turned off, so that supply of power to the hard disk drive 30 is stopped.

Thus, in the hard disk drive 30 having entered the standby mode, in which the spindle motor is stopped in the idle state, supply of power is stopped under the control of the conversion control LSI 28. Accordingly, it is possible to considerably reduce consumption of battery power by the hard disk subsystem 10 connected to the personal computer 18 via the USB cable 22.

After the hard disk drive 30 is powered off in step S4, since power is still being supplied to the conversion control LSI 28, in this state, in step S5, it is checked whether an access command, namely, a read command or a write command, from a host, such as a personal computer, has been received.

Upon receiving an access command from the host, the process proceeds to step S6. In step S6, the signal level of the GP-IO port 54 is changed to L level, whereby the P-type MOS-FET 52 is turned on. Accordingly, the hard disk drive 30 is powered on and activated.

In the conversion control LSI 28, even in the state where the hard disk drive 30 is powered off, the hard disk drive 30 is regarded as being in a device ready state when viewed from the external host side. Thus, although the hard disk drive 30 is actually powered off and is not operating, the host side assumes that the hard disk drive 30 is in effective operation and is in the device ready state, and sends an access command to the conversion control LSI 28.

Steps S1 to S6 are repeated until a stop instruction is received in step S7, for example, when the personal computer is logged off.

Although the embodiment described above is an example where a USB interface is used as an external interface of a personal computer used as an external apparatus, alternatively, for example, an eSATA interface or an IEEE-1394 interface may be used.

In the case where an IEEE-1394 interface is used as an external interface, since the IEEE-1394 interface is self-powered, the IEEE-1394 interface can be used similarly to a USB interface. Obviously, as the conversion control LSI 28, a conversion control LSI that converts signals between IEEE-1394 and ATA or SATA is used.

In the case where an eSATA interface is used as an external interface, since the eSATA interface is not self-powered, in this case, it is preferably to provide a power supply adaptor for power supply and to connect the power supply adaptor to the eSATA interface using a power supply cable. Alternatively, instead of using a power supply cable, it is possible to use a USB cable and receive power via the USB cable.

In this case, if the hard disk drive 30 has an ATA interface, as the conversion control LSI 28, a conversion control LSI that converts signals between ATA and SATA is used. If the hard disk drive 30 has an SATA interface, since interface conversion is not needed, as the conversion control LSI 28, an LSI having the function of the power supply controller 68 is used.

### 2. Second Embodiment

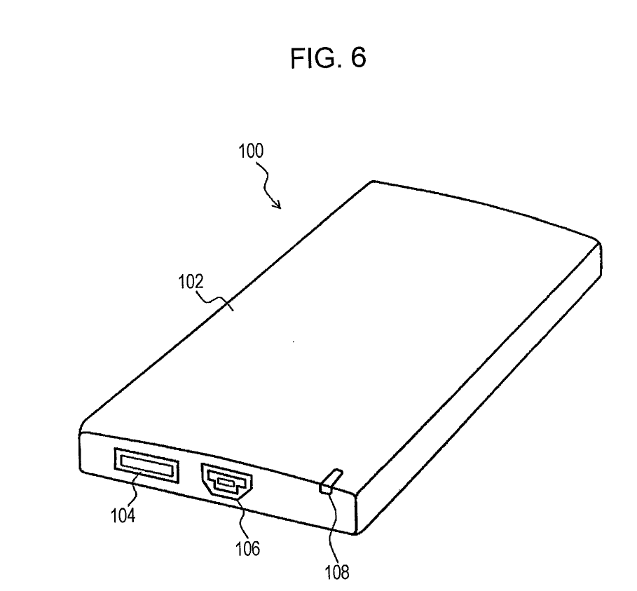

FIG. 6 is a diagram showing a hard disk subsystem that is a second embodiment of a storage apparatus. Referring to FIG. 6, a hard disk subsystem 100 has a palm-sized and book-shaped case 102 having a thickness of about 15 to 20 mm. Furthermore, in a front portion of the case 102, an eSATA connector 104, a B-type USB connector 106, and an LED indicator 108 are provided.

The eSATA connector 104 is connected to an eSATA cable extending from an external apparatus as an upper-level apparatus, such as a personal computer. The B-type USB connector 106 is connected to a USB cable extending from a personal computer. Upon connection of the USB cable to the B-type USB connector 106, power is supplied to the hard disk subsystem 100 so that the hard disk subsystem 100 is activated.

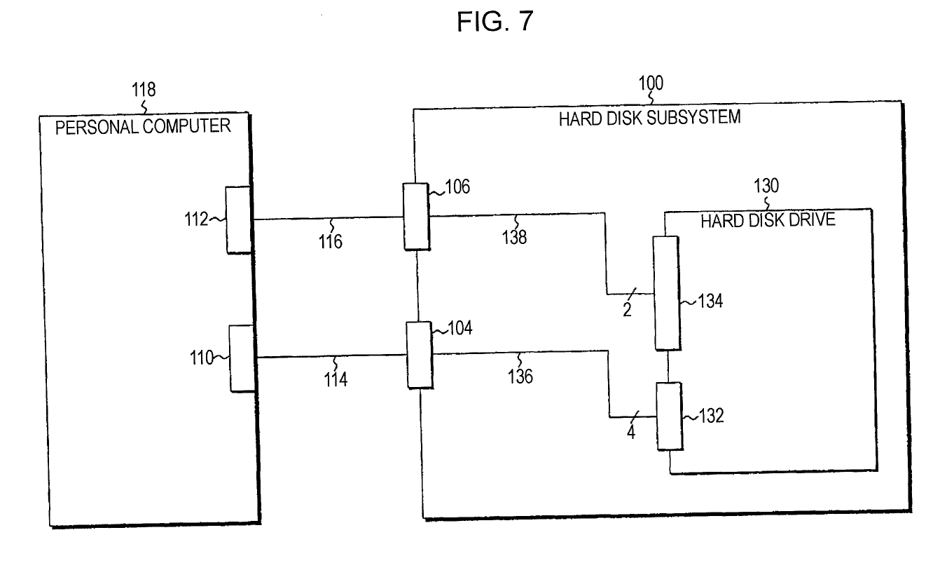

FIG. 7 is a block diagram showing the internal configuration of the hard disk subsystem 100 according to the embodiment shown in FIG. 6. Referring to FIG. 7, the hard disk subsystem 100 according to this embodiment is used as an external attachment to a personal computer 118.

More specifically, the personal computer 118 has an eSATA port and a USB port. Thus, an eSATA connector 110 of an eSATA cable 114 is connected to the eSATA port, and an A-type USB connector 112 of a USB cable 116 is connected to the USB port. Furthermore, the eSATA cable 114 is connected to the eSATA connector 104 of the hard disk subsystem 100, and the USB cable 116 is connected to the B-type USB connector 106 of the hard disk subsystem 100.

In the connector connection between the personal computer 118 and the hard disk subsystem 100 using the eSATA cable 114 and the USB cable 116, connectors on the side of the cables are male connectors, and connectors on the side of the personal computer 118 and the hard disk subsystem 100 are female connectors.

The hard disk subsystem 100 includes a hard disk drive 130 as a storage device. The hard disk drive 130 has an SATA interface.

The hard disk drive 130 has an SATA signal connector 132 and a power supply connector 134. The SATA signal connector 132 is connected to the eSATA connector 104 using an SATA signal cable 136. Furthermore, the power supply connector 134 is connected to the B-type USB connector 106 using a USB power supply cable 138.

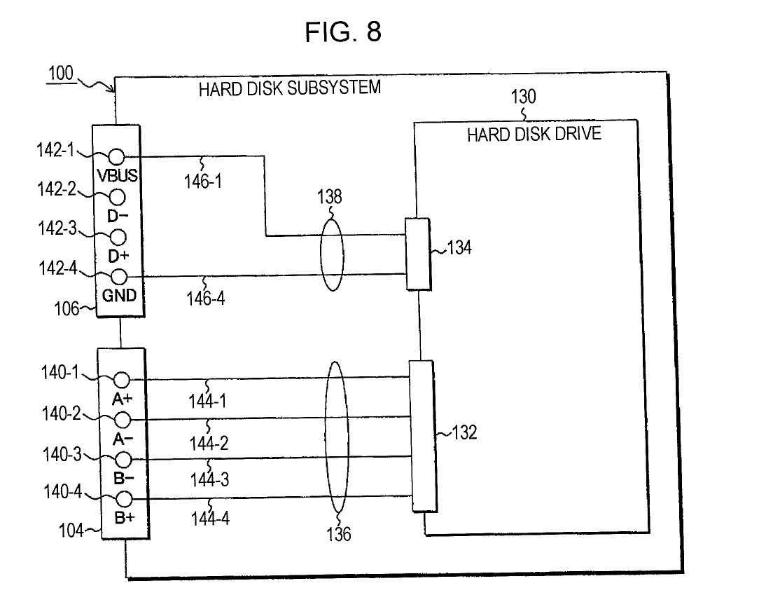

FIG. 8 is a block diagram showing the circuit configuration of the hard disk subsystem 100 according to the embodiment shown in FIG. 8. Referring to FIG. 8, the eSATA connector 104 has connector pins 140-1 to 140-4 respectively used as signal terminals A+, A−, B−, and B+.

The SATA signal cable 136 connecting the eSATA connector 104 with the SATA signal connector 132 of the hard disk drive 130 includes the four SATA signal lines 141-1 to 144-4.

In the SATA signal cable 136, the two SATA signal lines 144-1 and 144-2 forming the signal terminals A+ and A− constitute a downlink transmission circuit, and the two SATA signal lines 144-3 and 144-4 corresponding to the signal terminals B− and B+ constitute an uplink transmission circuit to the personal computer side, and the pair of uplink and downlink transmission circuits constitutes one lane.

The B-type USB connector 106 has four connector pins 142-1 to 142-4 denoted by VBUS, D−, D+, and GND, respectively. In this embodiment, a USB power supply line 146-1 extends from the VBUS connector pin 142-1 to which a power supply voltage of 5 volts for USB bus is supplied, and a USB ground line 146-4 extends from the connector pin 142-4 denoted by GND. Furthermore, the USB power supply line 146-1 and the USB ground line 146-4 are connected to the power supply connector 134 of the hard disk drive 130 as a power supply cable 138, so that a power supply voltage of 5 volts, which serves as a bus power for the USB interface, is supplied to the hard disk drive 130.

According to the second embodiment shown in FIGS. 6 to 8, as shown in FIG. 7, when the hard disk subsystem 100 is used as an external attachment to the personal computer 118, the eSATA cable 114 is used for connection. Thus, a power supply voltage that serves as a bus power for the USB interface is supplied through the USB cable 116 to the hard disk drive 130 of the hard disk subsystem 100, whereby the hard disk drive 130 is activated. For accesses for input and output between the hard disk drive 130 and the personal computer 118, high-speed transfer via the eSATA interface is used.

Thus, even in the case of the hard disk subsystem 100 having the eSATA interface, a special external power supply device, such as an AC adaptor, is not needed. Even in the case where, for example, a notebook personal computer is used as the personal computer 118, which is used in a mobile environment where it is not possible to use an AC power supply, the hard disk subsystem 100 is allowed to operate by a power supplied from the personal computer 118 through the USB interface, and high-speed data transfer is allowed by the eSATA interface.

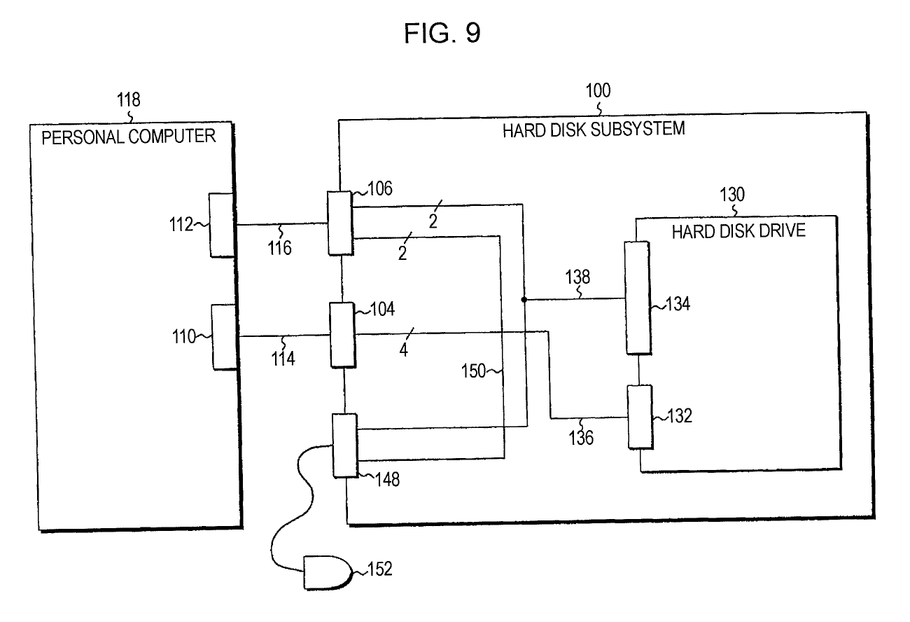

FIG. 9 is a diagram showing the internal configuration of a hard disk subsystem according to another embodiment of a storage apparatus. In the embodiment shown in FIG. 9, the hard disk subsystem 100 according to the embodiment shown in FIG. 7 further includes an A-type USB connector 148. The A-type USB connector 148 newly provided is connected to a USB power supply cable 138 and a USB signal cable 150 extending from the B-type USB connector 106 within the case of the hard disk subsystem 100.

Since the USB port of the personal computer 118 is occupied by the connection of the USB cable 116 to the A-type USB connector 112 in the hard disk subsystem 100, in order to compensate for the occupied USB port, the A-type USB connector 148, which is of the same type as the A-type USB connector 112 of the personal computer 118, is additionally provided on the hard disk subsystem 100, and the A-type USB connector 148 is connected to the USB port of the personal computer 118 via the B-type USB connector 106.

The A-type USB connector 148 additionally provided on the hard disk subsystem 100 is connected to, for example, a mouse 152, whose power consumption is relatively small. This serves to compensate for the occupation of the USB port of the personal computer 118 by the hard disk subsystem 100.

Instead of the mouse 152, the A-type USB connector 148, which is provided on the hard disk subsystem 100 so as to compensate for occupation of the USB port of the personal computer 118, may be connected, for example, to a device such as a USB stick including a flash memory, whose power consumption is small.

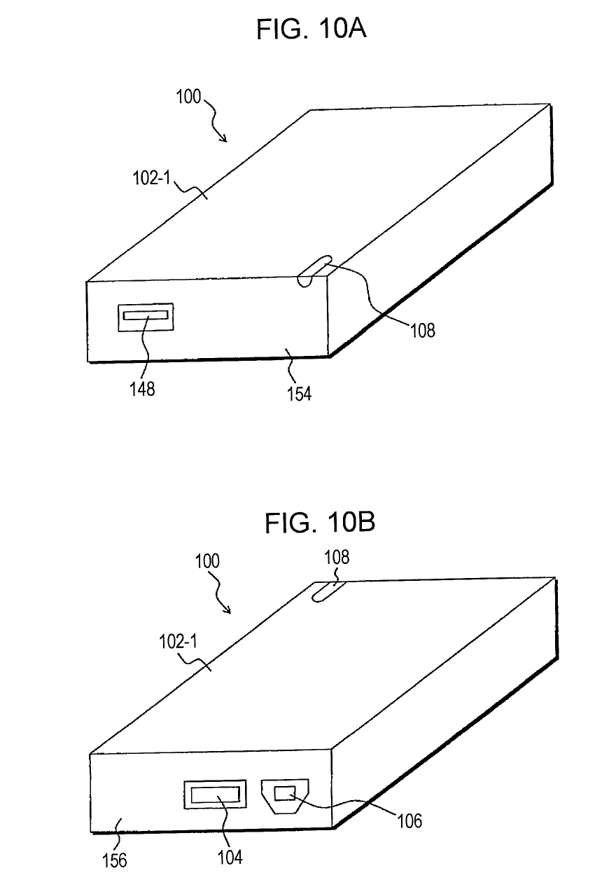

FIG. 10A shows the positions of connectors in the embodiment shown in FIG. 9, in which the hard disk subsystem 100 is viewed from the front side. On a front panel 154 of a case 102-1, the A-type USB connector 148 that compensates for the occupation of the USB port of the personal computer 118, to which the mouse 152 or the like is connected as shown in FIG. 9, is provided.

FIG. 10B shows the positions of connectors, in which the hard disk subsystem 100 is viewed from the rear side. On a rear panel 156 of the case 102-1, the eSATA connector 104 and the B-type USB connector 106 used to supply USB bus power are provided.

As described above, the A-type USB connector 148 is provided on the front panel 154, and the eSATA connector 104 and the B-type USB connector 106 are provided on the rear panel 156. Thus, in the case where the hard disk subsystem 100 is used as an external attachment to the personal computer 118 as shown in FIG. 9, the eSATA connector 104 and the B-type USB connector 106, for which connection is maintained during operation, are provided on the side of the rear panel 156, so that detachment or the like of a connector after a connection is once formed is avoided. On the other hand, the A-type USB connector 148 is provided on the side of the front panel 154. Thus, it is possible to use the A-type USB connector 148 instead of the USB port occupied by the personal computer 118, so that it is readily possible to connect the mouse 152 or to connect a memory stick.

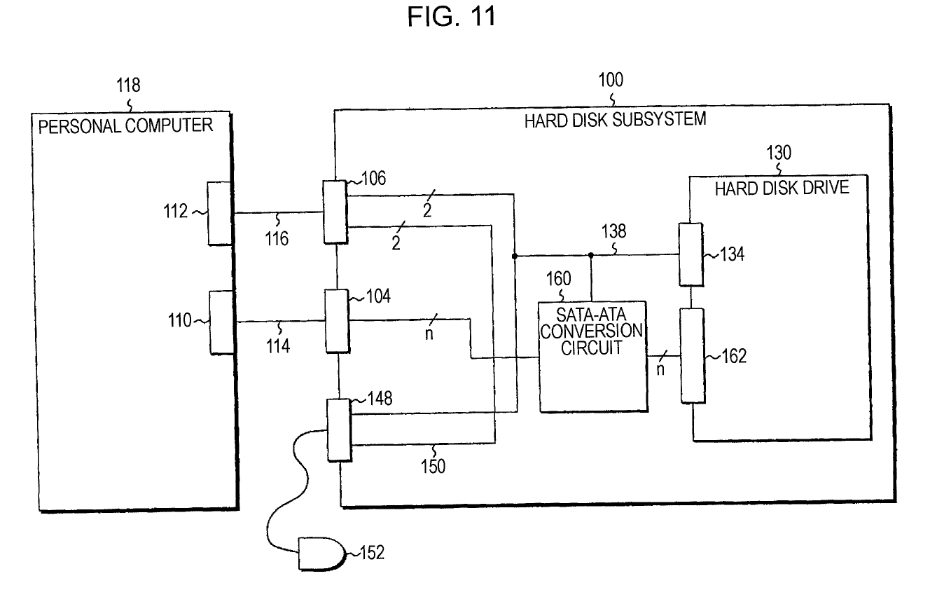

FIG. 11 is a diagram showing a hard disk subsystem according to another embodiment of a storage apparatus. In the embodiment shown in FIG. 11, as an interface of the hard disk drive 130 provided as a storage device of the hard disk subsystem 100, the hard disk drive 130 having an ATA interface, which is readily available at low price, is used.

The ATA interface is a name of IDE interface standardized by ANSI, which had been used as a parallel ATA interface before the SATA interface.

In the hard disk subsystem 100 including the hard disk drive 130 having the ATA interface as described above, as an interface with the personal computer 118, similarly to the embodiments shown in FIGS. 6 and 9, in order to achieve high-speed transfer using an eSATA interface, an SATA-ATA conversion circuit 160 is provided in the hard disk subsystem 100.

The other configuration of the hard disk subsystem 100 is the same as that in the embodiment shown in FIG. 9. That is, in addition to the eSATA connector 104 and the B-type USB connector 106, the hard disk subsystem 100 includes the A-type USB connector 148 that compensates for the occupation of the USB port of the personal computer 118 by the external attachment of the hard disk subsystem 100, so that the mouse 152 or the like can be connected.

The USB power supply cable 138 extending from the B-type USB connector 106 is connected to the power supply connector of the hard disk drive 130 to supply USB bus power, and is connected to the SATA-ATA conversion circuit 160 to supply USB bus power so that a conversion operation is executed. The A-type USB connector 148 is connected to the B-type USB connector 106 via the USB power supply cable 138 and the USB signal cable 150.

As described above, according to the embodiment shown in FIG. 11, also in the case where the hard disk drive 130 having an ATA interface, which is readily available at low price, is used in the hard disk subsystem 100, high-speed transfer via an eSATA interface with the personal computer 118 is allowed.

As for power supply, bus power of the USB interface is used, so that external connection of a special power supply device, such as an AC adaptor, is not needed. Furthermore, the A-type USB connector 148 of the same type as the A-type USB connector of the personal computer 118 provided in the hard disk subsystem 100 compensates for the occupation of the USB port of the personal computer 118 for power supply. Thus, it is possible to connect a device with relatively low power consumption, such as the mouse 152 or a memory stick, on the side of the hard disk subsystem 100 using a USB cable.

The embodiment described above is an example where a hard disk subsystem including a hard disk drive as a storage device is used. However, without limitation to the embodiment, application is similarly possible to an optical disk subsystem including an optical disk drive as a storage device.

The turn of the embodiments isn't a showing the superiority of the invention. Although the embodiments of the present inventions has been described in detail, it should be understood that the various changes, substitutions, and alterations could be made hereto without departing from the spirit and scope of the invention.

What is claimed is:

1. A storage apparatus used as an external attachment to an external apparatus, the storage apparatus comprising:
a storage device with which data is input from and output to an external apparatus having an external interface;
a power supply control switch provided on a power supply line through which power is supplied to the storage device; and
a conversion control circuit that converts signals mutually between a device interface of the storage device and the external interface, and that performs control to turn off the power supply control switch so that supply of power to the storage device is stopped upon the storage device entering an idle state, the idle state being a state where input to and output from the external apparatus are absent.

2. The storage apparatus according to claim 1, wherein, after performing control to turn off the power supply control switch so that supply of power to the storage device is stopped, upon receiving an input or output request from the external apparatus, and the conversion control circuit performs control to turn on the power supply control switch so that power is supplied to the storage device and the storage device is reactivated.

3. The storage apparatus according to claim 1, wherein capacitors that cut off direct-current power are connected on individual signal lines of the device interface, the signal lines interconnecting the storage device and the conversion control circuit.

4. The storage apparatus according to claim 1, wherein the device interface is an SATA interface, and the external interface is a USB interface, an eSATA interface, or an IEEE-1394 interface.

5. The storage apparatus according to claim 1, wherein, after entering the idle state, each time a predetermined time elapses, the storage device progressively increases a degree of power saving, and upon detecting the storage device entering a state with a highest degree of power saving, the conversion control circuit performs control to turn off the power supply control switch so that supply of power to the storage device is stopped.

6. The storage apparatus according to claim 1, wherein the storage device is a magnetic disk device, and after entering the idle state, each time a predetermined time elapses, the storage device changes its power saving mode progressively in order of a VCM-lock power saving mode, a head-unload power saving mode, and a spindle-stop power saving mode, in that order, the VCM-lock power saving mode being a mode in which a voice coil motor that drives a head actuator is stopped, the head-unload power saving mode being a mode in which the head actuator is returned to a stop position so that supply of power to the voice coil motor is stopped, and the spindle-stop power saving mode being a mode in which a spindle motor that rotates a disk medium at a constant speed is stopped, and upon detecting the spindle-stop power saving mode, the conversion control circuit performs control to turn off the power supply control switch so that supply of power to the magnetic disk device is stopped.

7. A storage apparatus used as an external attachment to an external apparatus, the storage apparatus comprising:
a storage device having an SATA interface;
an eSATA interface connector connected to the storage device via an SATA signal cable, and removably connectable to an eSATA signal cable extending from the external apparatus; and
a B-type USB connector connected to the storage device via a power supply cable having a power supply line and a ground line, and removably connectable to a USB cable extending from the external apparatus.

8. The storage apparatus according to claim 7, further comprising an A-type USB connector connected to a power supply line, a ground line, and a pair of signal lines extending from the B-type USB connector.

9. The storage apparatus according to claim 8, wherein the eSATA interface connector and the B-type USB connector are provided on a rear panel side of a case of the storage apparatus, and the A-type USB connector is provided on a front panel side of the case of the storage apparatus.

10. A storage apparatus used as an external attachment to an external apparatus, the storage apparatus comprising:
a storage device having an ATA interface;
an eSATA interface connector removably connectable to an eSATA signal cable extending from the external apparatus;
an interface conversion circuit that is provided between the storage device and the eSATA interface connector and that converts signals between the ATA interface and an eSATA interface; and
a B-type USB connector connected to the storage device via a power supply cable having a power supply line and a ground line, the B-type USB connector being removably connectable to a USB cable extending from the external apparatus.

11. The storage apparatus according to claim 10, further comprising an A-type USB connector connected to a power supply line, a ground line, and a pair of signal lines extending from the B-type USB connector.

12. The storage apparatus according to claim 11, wherein the eSATA interface connector and the B-type USB connector are provided on a rear panel side of a case of the storage apparatus, and the A-type USB connector is provided on a front panel side of the case of the storage apparatus.
